(19) United States
(12) Patent Application Publication
(10) Pub. No.: US 2021/0004755 A1
(43) Pub. Date: Jan. 7, 2021

(54) INVENTORY MANAGEMENT BY WEIGHT

(71) Applicant: Denis Bosotina, Rancho Palos Verdes, CA (US)

(72) Inventor: Denis Bosotina, Rancho Palos Verdes, CA (US)

(21) Appl. No.: 16/503,140

(22) Filed: Jul. 3, 2019

(51) Int. Cl. G06Q 10/08; G01G 19/414; G06Q 20/20

(52) U.S. Cl. CPC G06Q 10/087; G06Q 20/208; G06Q 20/203; G01G 19/4144

(57) ABSTRACT

An illustrated view of an exemplary reordering scale for managing inventory presented. The reordering scale is useful for tracking and reordering inventory of a product based on a calibrated weight ratio. The reordering scale is useful for reducing manual labor and errors made in inventory management by automating the reordering inventory and maintaining accurate accounts of amount of inventory is on hand. Further, the reordering scale can be useful for determining a calibrated weight of delivery and thus quickly and automatically determine accuracy of the delivery while adding the inventory to an inventory database.

### FIELD OF THE INVENTION

This invention relates to inventory control. More particularly, it relates to determining inventory by weight.

### BACKGROUND

Inventory (American English) or stock (British English) is the goods and materials that a business holds for the ultimate goal of resale (or repair).

Inventory management is a discipline primarily about specifying the shape and placement of stocked goods. It is required at different locations within a facility or within many locations of a supply network to precede the regular and planned course of production and stock of materials.

The concept of inventory, stock or work-in-process has been extended from manufacturing systems to service businesses and projects, by generalizing the definition to be “all work within the process of production—all work that is or has occurred prior to the completion of production.” In the context of a manufacturing production system, inventory refers to all work that has occurred—raw materials, partially finished products, finished products prior to sale and departure from the manufacturing system. In the context of services, inventory refers to all work done prior to sale, including partially process information.

It seems that around 1880 there was a change in manufacturing practice from companies with relatively homogeneous lines of products to horizontally integrated companies with unprecedented diversity in processes and products. Those companies (especially in metalworking) attempted to achieve success through economies of scope—the gains of jointly producing two or more products in one facility. The managers now needed information on the effect of product-mix decisions on overall profits and therefore needed accurate product-cost information.

A variety of attempts to achieve this were unsuccessful due to the huge overhead of the information processing of the time. However, the burgeoning need for financial reporting after 1900 created unavoidable pressure for financial accounting of stock and the management need to cost manage products became overshadowed. In particular, it was the need for audited accounts that sealed the fate of managerial cost accounting. The dominance of financial reporting accounting over management accounting remains to this day with few exceptions, and the financial reporting definitions of ‘cost’ have distorted effective management ‘cost’ accounting since that time. This is particularly true of inventory.

In reference to the foregoing, problems arise due to efficiency and accuracy of inventory management, therefore a device is needed to make the inventory management more efficient and more accurate.

### BRIEF DESCRIPTION OF THE DRAWINGS

FIG. 1A is an illustrated view of an exemplary reordering scale for a shelf.

FIG. 1B is an illustrated view of an exemplary reordering scale for a pallet.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

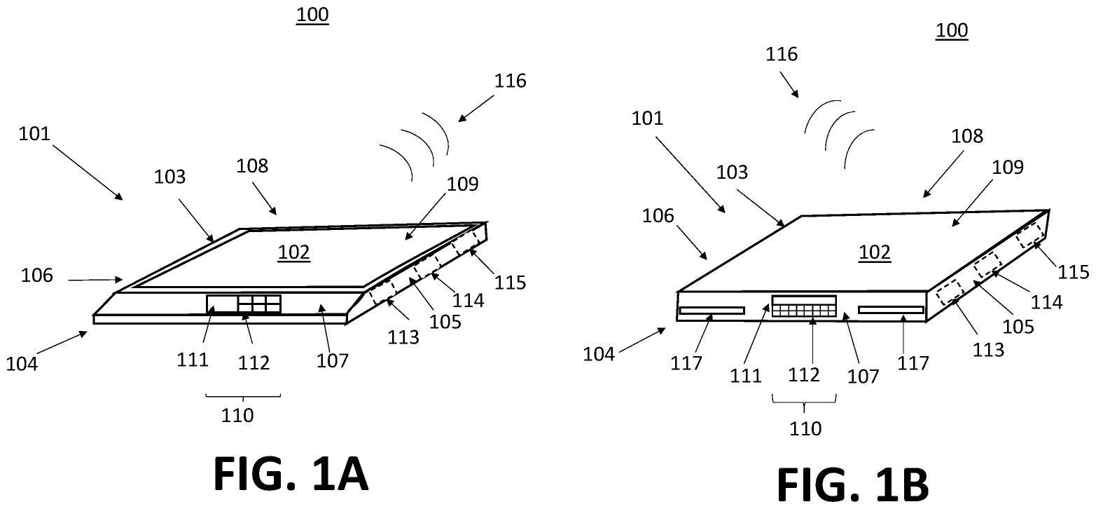

Referring to FIG. 1A and FIG. 1B, an illustrated view of an exemplary reordering scale 100 for managing inventory presented. The reordering scale 100 is useful for tracking and reordering inventory of a product based on a calibrated weight ratio. The reordering scale 100 is useful for reducing manual labor and errors made in inventory management by automating the reordering inventory and maintaining accurate accounts of amount of inventory is on hand. Further, the reordering scale 100, shown in FIG. 1B, can be useful for determining a calibrated weight of delivery and thus quickly and automatically determine accuracy of the delivery while adding the inventory to an inventory database.

Each of the two reordering scales 100 of FIG. 1A and FIG. 1B slightly vary and any common aspects will be described while any differences, additions, modifications, etc. will specify whether these are shown in FIG. 1A or FIG. 1B. FIG. 1A is useful when inventory is located on a shelf, table, etc. while FIG. 1B is considered to be useful for delivery of inventory or inventory in bulk storage, such as a warehouse.

The reordering scale 100 is preferably one (1) foot in width, but other widths are hereby contemplated including, but not limited to, three (3) feet, four (4) feet, etc. The reordering scale 100 is preferably one (1) foot in length, but other lengths are hereby contemplated including, but not limited to, three (3) feet, four (4) feet, etc. The reordering scale 100 is preferably six (6) inches in height, but other heights are hereby contemplated including, but not limited to, three (3) inches, nine (9) inches, etc. The reordering scale 100 is preferably a square shape, but other shapes are hereby contemplated including, but not limited to, rectangular, round, oblong, hexagonal, trapezoidal, etc.

The reordering scale 100 has a base 101 and a plate 102. The base 101 provides a foundation for the plate 102 and any weight that is put on the plate 102. The base 101 has a top 103, a bottom 104, a first side 105, a second side 106, a front 107, a back side 108 and an interior 109.

The plate 102 is communicatively coupled to the top 103 of the base 101. The top 103 supports the plate 102 and any weight which may be configured to be on the plate 102.

The front 107 of the reordering scale 100 has a control center 110. The control center 110 is useful for controlling all aspects of the reordering scale 100. The control center 110 has a display 111 and a keypad 112.

The display 111 is preferably a light emitting diode (LED) display, but other types of displays are hereby contemplated including, but not limited to, liquid crystal display (LCD), touch-screen, etc.

The keypad 112 is configured to be in communicative coupling with the display 111. The keypad 112 is preferably a touchpad, but other types of keypads are hereby contemplated including, but not limited to, toggle switches, alphanumeric keypad, etc. The keypad 112 is useful for setting thresholds for weight of inventory, selecting inventory type, setting communications parameters, etc.

The interior 109 is configured to have the “brains” of the reordering scale 100. The interior 109 has a computer device 113, a communications module 114 and a power source 115. The power source 115 of the interior 109 of the reordering scale 100 provides electrical power to the reordering scale 100. The power source 115 is preferably a twelve-volt (12 v) direct current (DC) power supply, but other power sources are hereby contemplated, such as, but not limited to, a rechargeable battery a NiCad battery, disposable batteries, AC/DC, etc.

The communications module 114 is useful for communicating with external entities. The communications module 114 is preferably a WiFI communications module, but other communications modules are hereby contemplated including, but not limited to, Wide Area Network (WAN), 4G, 5G, wired, etc. The communications module 114 sends signaling 116 to the external entities. The signaling 116 is preferably IEEE 802.11 signaling, but other types of signaling are hereby contemplated including, but not limited to, 3GPP, 3GPP2, IEEE 802.15 (Bluetooth®), etc. The communications module 116 is electrically coupled to the power source 115.

The computing device 113 is useful for computing signals commands and data received from the plate 102, the control center 110 and the communications module 114. The computing device 113 is electrically coupled to the power source 115. The computing device 113 is communicatively coupled to the communications module 114, thereby sending and receiving information from the external entities.

The computing device 113 is communicatively coupled to the control center 110. The control center 110 receiving input at the keypad 112 and transmitted to the control center 110. The input of the keypad 112 may include thresholds of weight for reordering, type of inventory, etc. The computing device 113 may send information to information to the control center 110 to be displayed at the display 111.

The computing module 113 is communicatively coupled to the plate 102 for receiving signaling which contains information such as, but not limited to, weight information, etc. The computing device 113 receiving the weight information from the plate 102 and calibrating the amount of weight of the inventory. The computing device 113 then compares the calculated inventory weight and determines the amount of inventory. When the threshold received and stored from the control center 110 is met, then the computing device 113 signals the communications module 114 to send a command via the signaling 116 to one of the external entities to order or request additional inventory.

The bottom 104 preferably have feet (not shown). The feet of the bottom 104 are preferably non-skit pads, but other types of feet are hereby contemplated including, but not limited to, pedestal feet, felt pads, etc.

In FIG. 1B, the front 107 of the reordering scale has a first forklift hole 117 and a second forklift hole 118. The first forklift hole 117 and the second forklift hole 118 receive forks of a forklift to avoid damage to the reordering scale 100 when the reordering scale 100 is to be transported to another location. The reordering scale 100 used with the pallet is typically larger and weighs more than the reordering scale 100 being used for inventory on a shelf.

The plate 102 of the reordering scale 100 is preferably a metal plate, but other types of plates are hereby contemplated including, but not limited to, membrane plates, gel-filled plates, etc. The plate 102 determine coordinates of the weight of the inventory and transmits the coordinates or information to the computing device 113 for further calibration.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A recording scale for inventory management, the scale comprising:
a base, the base comprising:
a top;
a front, the front having a control center;
the control center having a display and a keypad;
an interior, the interior having a computing device, a communications module and a power source;
the computing device for receiving information from the control center, wherein at least a threshold for reordering being received, and wherein the computing device being communicative coupled to the communication module;
the communications module configured to send and receive signaling; and
a plate, the plate being for weighing an inventory, wherein the plate being communicative coupled to the computing device, and wherein the plate being communicating the weighing information of the device to the computing device for weight calibration.

2. The scale of claim 1, wherein the signaling being IEEE 802.11 (WiFi).

3. The scale of claim 1, wherein the communications module being configured for IEEE 802.11 (WiFI) communications.

4. The scale of claim 1, wherein the computing device for comparing the calibrated weight of the inventory to a threshold.

5. The scale of claim 4, wherein when the threshold being equal to or greater than the calibrated weight of the inventory, then the threshold sending an order to the communications module containing a reordering of the inventory.

6. The scale of claim 1, wherein the reordering scale being a square shape.

7. The scale of claim 1, wherein the reordering scale having a length of one (1) foot.

8. The scale of claim 1, wherein the reordering scale having a width of one (1) foot.

9. The scale of claim 1, wherein the reordering scale having a height of six (6) inches.

10. The scale of claim 1, wherein the plate being communicative coupled to a top of the of the base.

11. The scale of claim 1, wherein the display being a light emitting diode (LED) display.

12. The scale of claim 1, wherein the plate being made of a metal material.

13. The scale of claim 1, wherein the base further comprising:
a first fork lift hole and a second forklift hole, wherein the first forklift hole and the second forklift hole being for receiving forks of a forklift when the reordering scale being transported.

14. The scale of claim 1, wherein the reordering scale being for inventory management for inventory on a shelf.

15. The scale of claim 1, wherein the reordering scale being for inventory management for inventory on a pallet.

16. The scale of claim 1, wherein a bottom of the base having feet.

17. The scale of claim 16, wherein the feet being non-skid pads.

18. The scale of claim 1, wherein the reordering scale for a pallet being larger than the reordering scale for a shelf.
